(19) United States
(12) Patent Application Publication
(10) Pub. No.: US 2008/0267412 A1
(43) Pub. Date: Oct. 30, 2008

(54) Method and Apparatus for Embedding Auxiliary Information in a Media Signal

(75) Inventor: Job Cornelis Oostveen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,972

(22) PCT Filed: May 30, 2005
(86) PCT No.: PCT/IB05/51754

§ 371 Date: Dec. 4, 2006

(30) Foreign Application Priority Data
Jun. 2, 2004 (EP) 04102448.0

(51) Int. Cl. H04L 9/00

(52) U.S. Cl. 380/287

(57) ABSTRACT

The invention relates to a system for embedding auxiliary information in a media signal such as an audio visual signal. An apparatus comprises a quantization index modulator (103) which generates a modified signal by quantization index modulation of the media signal. The modified signal has distortions relative to the media signal which are dependent on the auxiliary information. The apparatus further comprises a perception processor (107) which generates a perceptual characteristic indicative of a perceptual sensitivity of the media signal to the distortions. The quantization index modulator (103) and perception processor (107) are coupled to a compensation processor (105) which generates an output signal by modifying a strength of the distortions of the modified signal in response to the perceptual characteristic. The invention combines quantization index modulation watermarking with perceptual models to provide an improved trade off between watermark imperceptibility and detection reliability.

### FIELD OF THE INVENTION

The invention relates to a method and apparatus for embedding auxiliary information in a media signal and in particular to embedding auxiliary information into a media signal using quantization index modulation.

### BACKGROUND OF THE INVENTION

Digital watermarking is concerned with embedding auxiliary information in audio-visual objects. Digital watermarking has a large number of applications including copy(right) protection, royalty tracking, commercial verification, added value content, interactive toys and many more. The classical approach to digital watermarking is essentially controlled noise addition, whereby a known noise-like signal is added to the original signal. An example of such a technique is known as spread spectrum watermarking. Watermark detection for additive watermarks is generally based on correlation between the received signal and a reference watermark. The resulting correlation value consists of a wanted term and an interference term. The interference term is the main reason why watermark techniques based on noise addition obtain less than optimal performance.

In the watermarking literature, more and more attention is directed towards watermarking schemes treating the host signal as side-information for the watermark-embedder. This information-theoretic approach has lead to watermarking schemes with very high capacity.

For example, recent publications have shown that, assuming certain attack models, optimal watermarking can be achieved by quantization. In essence quantization watermarking amounts to the following. In the space S of host signals s, N sets of code points Cₙ are chosen, where N is equal to the number of messages to be embedded (the payload of the watermark). Modifying a host signal s into a signal s embeds a message m, such that s and s are close and such that s is closer to a certain point c in Cₘ than any other point in any of the other code sets Cₙ, where n is different from m. Decoding a watermark amounts to finding the closest points c in the union of code point sets, and deciding upon the message m if and only if the point c is member of the code set Cₘ. This type of watermarking is usually referred to as Quantization Index Modulation (QIM).

Further details of QIM may for example be found in Chen, B. and Wornell, G. W., “Quantization index modulation: a class of provably good methods for digital watermarking and information embedding”, Transactions on Information Theory, IEEE, Volume: 47 Issue: 4, May 2001, Page(s): 1423-1443 and “Next generation techniques for robust and imperceptible audio data hiding”, by Chou, J., Ramchandran, K. and Ortega, A, IEEE International Conference on Acoustics, Speech, and Signal Processing, Proceedings, 2001 Volume: 3, Page(s): 1349-1352.

Usually practical schemes arising from this approach are based on (dithered) vector quantization and distortion compensation. The combination of these two techniques allows embedding of large amounts of information. Schemes using these techniques are usually called Distortion Compensated Quantization Index Modulation Watermarking (DC-QIM).

A problem with DC-QIM schemes is that it is relatively hard to adapt to the local image characteristics. In particular, it is difficult to control the visibility of the watermark. One approach for adapting a QIM watermark to local signal characteristics is known from Patent Cooperation Treaty (PCT) WO 03/053064. WO 03/053064 discloses a local adaptation of the quantization step-size as a method for improving the trade-off between robustness and visibility of the watermark.

Current approaches to controlling the perceptibility and detection reliability of QIM watermarks use simplistic models and in particular are based on an evaluation of the signal to noise ratio between the host signal and the watermark. Although this model is very useful for the purpose of analysis, it tends to result in a suboptimal trade-off between the imperceptibility and detection reliability of the watermark.

Hence, an improved system for embedding auxiliary information into a media signal would be advantageous and in particular a system allowing improved detection reliability, increased flexibility, facilitated implementation, improved imperceptibility and/or improved performance would be advantageous.

### SUMMARY OF THE INVENTION

Accordingly, the Invention preferably seeks to mitigate, alleviate or eliminate one or more of the above mentioned disadvantages singly or in any combination.

According to a first aspect of the invention, there is provided an apparatus for embedding auxiliary information in a media signal comprising: means for generating a modified signal by quantization index modulation of the media signal; the modified signal having distortions relative to the media signal dependent on the auxiliary information; means for generating a perceptual characteristic indicative of a perceptual sensitivity of the media signal to the distortions; and means for generating an output signal by modifying a strength of the distortions of the modified signal in response to the perceptual characteristic.

The inventor of the current invention have realized that improved quantization index modulation performance can be achieved by modifying a strength of the distortions introduced by quantization index modulation in response to a perceptual characteristic. An improved performance is achieved and in particular the perceptibility of the distortions may be reduced and/or the detection reliability of the auxiliary information may be increased.

The media signal may for example be an audio and/or video signal. The media signal may for example be a streaming signal or may be a file comprising digital data. The auxiliary information may in particular be a digital watermark. The perceptual characteristic may be a characteristic indicating a perceptual difference to a user between the media signal and the modified signal.

According to a preferred feature of the invention, the strength of the distortions is operable to modify the strength by modifying a distortion compensation parameter. This provides a particularly advantageous performance. Alternatively or additionally, implementation may be facilitated as a simple, efficient and/or flexible means of modifying the strength of the distortions is achieved. In particular, the feature may be suitable for existing methods of quantization index modulation.

According to a preferred feature of the invention, the means for modifying the strength of the distortions is operable to dynamically adjust the strength of a distortion in response to a local perceptual sensitivity of the media signal local to the distortion.

The strength is preferably dynamically controlled to reflect the specific conditions of the part of the medial signal currently being modified. Thus, the trade off between imperceptibility and detection reliability may be dynamically optimized to reflect the changing characteristics of the signal.

According to a preferred feature of the invention, the means for generating the output signal is operable to scale the distortions in response to the perceptual characteristic. This provides for an advantageous way of modifying the strength and may allow a simple and practical implementation.

According to a preferred feature of the invention, the means for generating the output signal is operable to increase the strength for a decreasing perceptual sensitivity. This allows an improved trade-off between the imperceptibility of the distortions and the detection reliability of the auxiliary information. In particular, the strength may be increased as much as possible without making the distortions perceptible to a user of the resulting signal.

According to a preferred feature of the invention, the means for generating the modified signal is operable to determine the distortions, wⱼ, substantially as:

$${\underline{s}}_{j} = ( Round ( \frac{( \frac{{s}_{j} + {v}_{j}}{D} + {b}_{j} )}{2} ) \cdot 2 - {b}_{j} ) * D - {v}_{j}$$

wherein sⱼ is sample j of the media signal, D is a quantization interval, vⱼ is a dither value for sample j, and bⱼ is bit j of the auxiliary information. This provides for a low complexity implementation with high performance.

According to a preferred feature of the invention, the means for generating the output signal is operable to determine the output signal, s_{out,j}, comprising the signal substantially as:

s_{out,j}=sⱼ+α·wⱼ

wherein sⱼ is sample j of the media signal and wⱼ is a distortion for sample j determined by the quantization index modulation of the media signal and α is a distortion compensation parameter; and the means for generating the output signal is operable to modify the distortion compensation parameter α in response to the perceptual characteristic.

This provides a particularly simple technique to implement, analyze and/or control the strength of the distortions.

According to a preferred feature of the invention, the media signal is a visual signal and the perceptual characteristic is an indication of a texture level of an image region. The visual signal may for example be a video signal or a picture file. Preferably the strength will be increased for increasing texture levels. The perceptibility of distortions to a media signal typically increases for increasing texture levels and the feature allows this to be utilized to provide an improved trade off between imperceptibility and detection performance.

According to a preferred feature of the invention, the media signal is an audio signal and the perceptual characteristic is an indication of an audio level of an audio segment. The audio signal may for example be a digitally encoded music signal. Preferably the strength will be increased for increasing audio levels. The perceptibility of distortions to an audio media signal typically increases for increasing audio levels and the feature allows this to be utilized to provide an improved trade off between imperceptibility and detection performance.

According to a preferred feature of the invention, the means for generating the perceptual characteristic is operable to generate the perceptual characteristic in response to a perceptual model comprising a Laplacian filter. This provides a suitable way of determining a perceptual characteristic which is useful for controlling the strength of the distortions for many types of media signal.

According to a preferred feature of the invention, the means for generating the perceptual characteristic is operable to generate the perceptual characteristic in response to a perceptual model comprising a Girod's W-model. This provides a suitable way of determining a perceptual characteristic which is useful for controlling the strength of the distortions for many types of media signal.

According to a second aspect of the invention, there is provided a method of embedding auxiliary information in a media signal, the method comprising the steps of: generating a modified signal by quantization index modulation of the media signal; the modified signal having distortions relative to the media signal dependent on the auxiliary information; generating a perceptual characteristic indicative of a perceptual sensitivity of the media signal to the distortions; and generating an output signal by modifying a strength of the distortions of the modified signal in response to the perceptual characteristic.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 is an illustration of a block diagram of an apparatus for embedding a watermark in accordance with an embodiment of the invention.

### DESCRIPTION OF PREFERRED EMBODIMENTS

The following description focuses on an embodiment of the invention applicable to embedding a digital watermark in a digitally encoded audiovisual signal.

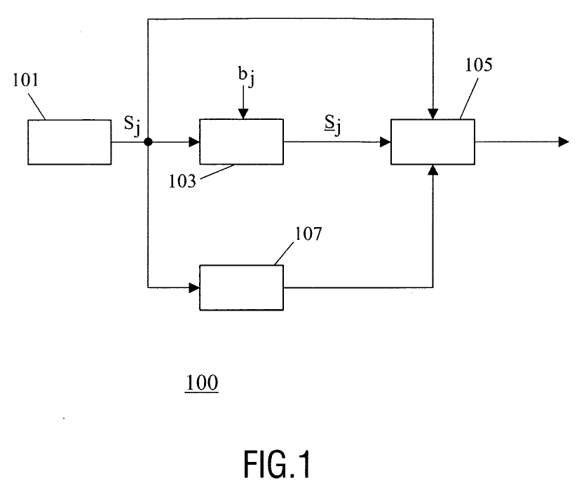

FIG. 1 is an illustration of a block diagram of an apparatus for embedding a watermark in accordance with an embodiment of the invention.

In the example, the apparatus comprises a local signal source 101 which generates a media signal. The media signal may for example be a data file comprising a digitally encoded video and/or audio clip. It will be appreciated that in other embodiments, the media signal may be received from other sources such as for example from an external source. It will also be appreciated that the media signal may be of any suitable form and may for example be a streaming signal.

The local signal source 101 is coupled to a quantization index modulator 103 which is fed the media signal. In particular, the quantization index modulator 103 is fed the media signal as a number of samples henceforth denoted by sⱼ where j denotes the sample number.

The quantization index modulator 103 is operable to embed samples bⱼ of auxiliary information, and thus generate a modified signal by quantization index modulation of the media signal. Thus, a modified signal sⱼ is generated which has distortions relative to the media signal. The distortions will be dependent on the auxiliary information. However, in contrast to a noise additive watermark technique, the distortions do not directly correspond to the auxiliary information but rather the auxiliary information is comprised in the quantization applied to the media signal and thus in the combination of the signal and the distortions.

In more detail, by way of example, the quantization index modulation may be most easily understood by considering scalar quantization of signal sample values. A quantization interval, D, is selected and used to construct two code sets Co and C₁ as follows: the set Co consists of all even multiples of D and the set C₁ consists of all odd multiples of D. In its simplest form, watermarking a signal s=(s₁, s₂, . . . sₖ) of length k with a bit string (the watermark) b=(b₁, b₂, . . . bₖ) of length k is achieved by for each j rounding sⱼ to the nearest even multiple of D when bⱼ=0 and to the nearest odd multiple of D when bⱼ=1. Thus, the quantization index modulation maps an input sample sⱼ to a modified output sample sⱼ which is dependent on the watermark bit bⱼ.

The bit string b can be recovered by rounding the resulting signal to the grid spanned by D and setting the bit value to 0 if the rounding results in a value being an even multiple of D and to 1 if the rounding results in a value being an even multiple of D.

In many practical systems, the signal samples are dithered by adding a dither value vⱼ to each sample in order to improve security and to spread and randomize the introduced quantization noise. The dither values vⱼ are preferably real numbers. This prevents the samples sⱼ from always being on the grid spanned by D whereby the presence of the watermark becomes obscured.

Specifically, the quantization index modulator 103 may perform the following operation known as “dithered uniform scalar quantization”

The dither value vⱼ will be expressed as a fractional value of the quantization step and in particular −1<vⱼ<1. The discrete levels that an output sample sⱼ can assume for a given offset vⱼ is:

sⱼ₌₍2 m+bⱼ)·D+vⱼ·D (1)

where m is an integer value.

The output value sⱼ must be as close as possible to the input value sⱼ. This can be expressed as

$$\begin{matrix}{s}_{j} ≅ {\underline{s}}_{j} & ( 2 ) \\ {s}_{j} ≅ ( 2 m + {b}_{j} ) \cdot D + {v}_{j } \cdot D & ( 3 ) \\ m ≅ \frac{{s}_{j} - ( {v}_{j} + {b}_{j} ) \cdot D}{2 D} & ( 4 )\end{matrix}$$

This condition is met by setting

$$m = Round ( \frac{{s}_{j} - ( {v}_{j} + {b}_{j} ) \cdot D}{2 D} ) \qquad ( 5 )$$

Substitution of (5) in (1) yields:

$${\underline{s}}_{j} = ( Round ( \frac{( \frac{{s}_{j}}{D} + {v}_{j} + {b}_{j} )}{2} ) \cdot 2 - {v}_{j} - {b}_{j} ) * D \qquad ( 6 )$$

Equation 6 may be interpreted in the following way. Firstly, for the sample value sⱼ, a “quantization index” sⱼ/D is calculated. Secondly, this quantization index is rounded to a shifted version corresponding to the set of even or odd integer values (offset by vⱼ) depending on whether bⱼ is one or zero. Thus, depending on the value of bⱼ, the quantization index modulated signal samples lie on two distinct subsets. Finally, the result is multiplied by D to restore the original scale of the sample value sⱼ.

Thus, in the described embodiment, the quantization index modulator 103 generates a modified signal sⱼ. The modified signal comprises distortions wⱼ with respect to the original signal sⱼ given by:

$${w}_{j} = {s}_{j} - ( Round ( \frac{( \frac{{s}_{j}}{D} + {v}_{j} + {b}_{j} )}{2} ) * 2 - {v}_{j} - {b}_{j} ) * D \qquad ( 7 )$$

The distortions thus depend on the watermark data. However, in contrast to typical noise additive watermarking, the distortions do not directly correlate to the watermark. Rather the watermark information is comprised in the combination of the signal and the distortions.

It will be appreciated that the quantization index modulation is not necessarily limited to binary data symbols but may also be applied to higher order data symbols.

As is well known in the art, detection of information embedded by quantization index modulation may be performed by computing the quantization index, taking into account the dither values, and checking for the parity of the quantization index. For the binary case a watermark detector may simple calculate a bit value bⱼ of the watermark from:

$${\underline{b}}_{j} = Mod ( Round ( \frac{{s}_{j}}{D} ) + {v}_{j} , 2 ) \qquad ( 8 )$$

In order to vary the impact and perceptibility of the watermark to a user being presented the modified media signal, distortion compensation may be applied. Accordingly, the apparatus of FIG. 1 comprises a compensation processor 105 which generates an output signal by modifying a strength of the distortions of the modified signal.

In particular, the compensation processor 105 generates an output signal sₒᵤₜ given by

s_{out,j}=sⱼ+α·wⱼ (9)

wherein sⱼ is sample j of the media signal and wⱼ is the distortion for sample j determined by the quantization index modulator 103. Thus, in the described embodiment, the distortions w are scaled by a distortion compensation parameter α.

Hence, the distortions w introduced by the quantization index modulator 103 may be considered the difference between the original sample and the watermarked sample and w may be interpreted as the modification or error introduced by the quantization index modulator 103. The additional parameter of the distortion compensation parameter α may be used to control the magnitude or strength of the modifications. A distortion parameter value of α=1 corresponds to the original quantization index modulation and for α=0 no modification to the original media signal is made.

In the embodiment of FIG. 1, the compensation processor 105 receives the original signal sⱼ from the signal source 101 and the modified signal sⱼ from the quantization index modulator 103. It then calculates the distortion wⱼ for each sample, multiplies the distortion by the distortion compensation parameter α and adds the result to the original signal sⱼ. Thus, the compensation processor 105 generates an output signal by modifying a strength of the distortions of the modified signal by performing the operation:

s_{out,j}=sⱼ+α·(sⱼ−sⱼ) (10)

It will be appreciated that the distortion compensation does not require a different watermark detection algorithm and that the same detector can be used independently of the value of distortion compensation parameter α.

In accordance with the described embodiment, the apparatus of FIG. 1 further comprises a perception processor 107. The perception processor 107 generates a perceptual characteristic indicative of a perceptual sensitivity of the media signal to the distortions. In particular, the perception processor 107 may determine a perceptual characteristic that indicates how noticeable distortions or modifications to the original media signal are to a user. For example, for a video signal, the perceptual characteristic may indicate how sensitive the media signal is to distortions becoming visually noticeable.

In the apparatus of FIG. 1, the perception processor 107 is coupled to the compensation processor 105 and is operable to control the distortion compensation parameter α. Thus, the strength of the distortions of the modified signal is controlled in response to the perceptual characteristic.

This may allow the distortions to be optimized for the signal characteristics and may in particular provide for an improved trade off between the imperceptibility of the distortions and the detection reliability of the embedded watermark.

Preferably, the strength of the distortions is increased for a decreasing perceptual sensitivity. Thus, when distortions are less noticeable, the distortion compensation parameter α is increased resulting in increased detection reliability while ensuring that the watermark embedding does not result in unacceptable quality degradations. When the perceptual sensitivity increases, smaller distortions may be noticeable and accordingly the distortion compensation parameter α is reduced thereby ensuring that the quality degradation does not become unacceptable.

In the described embodiment, the perception processor 107 implements a perceptual model which processes the media signal to determine the perceptual characteristic. The perceptual model preferably generates a local perceptual characteristic indicative of the local perceptual sensitivity. In particular, a perceptual characteristic may be generated for each sample based on the characteristics of a group of samples surrounding the sample.

As a specific example for a video application, the perception processor 107 may implement a perceptual model comprising a Laplacian filter. The Laplacian filter is a high-pass filter which generates a signal indicating whether a region in an image or video-frame is flat or textured. For flat regions where even small distortions may be easily visible, the filter will have a weak response. In textured regions, where distortions are less visible, the filter has a strong response. Thus, the output of the Laplacian filter is indicative of the perceptual sensitivity and may therefore be used to control the distortion compensation parameter α.

Thus, the described embodiment provides a way of combining the use of the high performance watermarking algorithm quantization index modulation with a perceptual evaluation. Based on the outcome of the perceptual model, the distortion compensation parameter α is increased (when the perceptual model indicates that even relatively large modifications are imperceptible) or decreased (when the perceptual model indicates that small modifications are needed to guarantee imperceptibility) relative to a default value.

In mathematical terms, let sᵢ be the signal sample to be watermarked and let (s_{i-N}, . . . s_{i+M}) be the samples in an environment of sᵢ. Assuming the visual model returns large values when large distortions are still imperceptible and small values when distortions must be small to be imperceptible. Let P(s_{k-N}, . . . s_{k+M}) be the perceptual model, and let g( ) be a suitably chosen monotonously increasing function, taking values in the interval [0,1]. Then the perceptual-adaptive embedding may be:

sᵢ=sᵢ+aᵢ·wᵢ, where

aₖ=g(P(s_{i-N} . . . s_{i+M})) (11)

and wᵢ is defined as in equation (7).

An example for watermarking of greyscale images (given by the pixel-intensities x_{r,c}) using the Laplacian filter as the perceptual model P and a linear function g(z)=γz+b the following term may be used to determine the distortion compensation parameter a_{r,c}:

a_{r,c}=b+γ·(−x_{r-1,c-1}−x_{r-1,c}−x_{r-1,c+1}−x_{r,c-1}+8x_{r,c}−x_{r,c+1}−x_{r+1,c-1}−x_{r+1,c}−x_{r+1,c+1})

It will be appreciated that other means of determining the perceptual characteristic may be used and that in particular other perceptual models may alternatively or additionally be used.

For example, the perception processor 107 may generate the perceptual characteristic in response to a perceptual model comprising a Girod's W model.

This model estimates the amount of “just-not-noticeable” noise as a function of the (uniform) background luminance. It is an adaptation of Weber's law, which states that the minimum perceivable difference between two stimuli is proportional to the intensity of the stimuli. Further information on Girod's W model may for example be found in “The information theoretical significance of spatial and temporal masking in video signals”, by Bernd Girod, “Human vision, Visual processing ad digital display”, volume 1077 of Proceedings of SPIE (the international society for optical engineering) pages 178-187, 1989.

It will also be appreciated that the invention is not limited to a visual signal but may be applied to many different types of media signals. For example, the media signal may be an audio signal such as a digitally sampled and PCM (pulse code modulation) encoded audio clip. In this example, the perceptual characteristic may be an indication of the audio level of an audio and the distortion compensation parameter α may be increased for increasing audio levels as these correspond to higher signal values for which distortions are less noticeable to a listener.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality. Reference signs in the claims are provided merely as a clarifying example and shall not be construed as limiting the scope of the claims in any way.

1-14. (canceled)

15. An apparatus for embedding auxiliary information in a media signal, comprising:
means for embedding said auxiliary data (bⱼ) by quantization index modulation of the media signal (sⱼ) to obtain a quantization index modulated signal (sⱼ); and
means for applying distortion compensation to the quantization index modulated signal (sⱼ) using a distortion compensation parameter (α) to obtain an output signal (sₒᵤₜ) according to
s_{out,j}=sⱼ+α·(sⱼ−sⱼ)
where j denotes a signal sample index;
means for generating a perceptual characteristic indicative of a perceptual sensitivity to distortions of the media signal;
characterized in that the means for applying distortion compensation are arranged to modify the distortion compensation parameter (α) in response to the perceptual characteristic.

16. The apparatus as claimed in claim 15 wherein means for applying distortion compensation is operable to dynamically adjust the distortion compensation parameter (α) in response to a local perceptual sensitivity of the media signal local to the distortion.

17. The apparatus as claimed in claim 15, wherein the means for applying distortion compensation is operable to scale the distortion compensation parameter (α) in response to the perceptual characteristic.

18. The apparatus as claimed in claim 15, wherein the means for applying distortion compensation is operable to increase the distortion compensation parameter (α) for a decreasing perceptual sensitivity.

19. The apparatus as claimed in claim 15, wherein the media signal is a visual signal and the perceptual characteristic is an indication of a texture level of an image region.

20. The apparatus as claimed in claim 15, wherein the media signal is an audio signal and the perceptual characteristic is an indication of an audio level of an audio segment.

21. The apparatus as claimed in claim 15, wherein the means for generating a perceptual characteristic is operable to generate the perceptual characteristic in response to a perceptual model comprising a Laplacian filter.

22. The apparatus as claimed in claim 15, wherein the means for generating a perceptual characteristic) is operable to generate the perceptual characteristic in response to a perceptual model comprising a Girod's W model.

23. A method of embedding auxiliary information in a media signal, comprising:
embedding said auxiliary data (bⱼ) by quantization index modulation of the media signal (sⱼ) to obtain a quantization index modulated signal (sⱼ);
applying distortion compensation to the quantization index modulated signal (sⱼ) using a distortion compensation parameter (α) to obtain an output signal (sₒᵤₜ) according to
s_{out,j}=sⱼ+α·(sⱼ−sⱼ)
where j denotes a signal sample index; and
generating a perceptual characteristic indicative of a perceptual sensitivity to distortions of the media signal,
characterized in that applying distortion compensation is arranged to modify the distortion compensation parameter (α) in response to the perceptual characteristic.

24. A computer program, embedded in a computer readable medium, for embedding auxiliary information in a media signal, comprising:
embedding said auxiliary data (bⱼ) by quantization index modulation of the media signal (sⱼ) to obtain a quantization index modulated signal (sⱼ);
applying distortion compensation to the quantization index modulated signal (sⱼ) using a distortion compensation parameter (α) to obtain an output signal (sₒᵤₜ) according to
s_{out,j}=sⱼ+α·(sⱼ−sⱼ)
where j denotes a signal sample index; and
generating a perceptual characteristic indicative of a perceptual sensitivity to distortions of the media signal,
characterized in that applying distortion compensation is arranged to modify the distortion compensation parameter (α) in response to the perceptual characteristic.
